(19) United States
(12) Patent Application Publication
(10) Pub. No.: US 2004/0150720 A1
(43) Pub. Date: Aug. 5, 2004

(54) Method and arrangement for testing video-technological devices

(76) Inventor: Andreas Loew, Gross-Gerau (DE)

Correspondence Address: JOSEPH S. TRIPOLI, Thomson Licensing Inc., 2 INDEPENDENCE WAY, P. O. BOX 5312, PRINCETON, NJ, 08543-5312, US

(21) Appl. No.: 10/626,045

(22) Filed: Jul. 24, 2003

(30) Foreign Application Priority Data
Sep. 12, 2002 (DE) 10242244.3

(51) Int. Cl. H04N 17/00

(52) U.S. Cl. 348/182

(57) ABSTRACT

A method and an arrangement for testing video-technological devices provides for a test signal to be generated in which the hue and the colour saturation are altered periodically.

### TECHNICAL FIELD

The invention relates to a method and an arrangement for testing video-technological devices.

### BACKGROUND OF THE INVENTION

The use of test signals for checking the quality of video-technological devices has been known for a long time, the intention also being to assess whether a video signal processing within such devices leads to alterations in the colour space. For this purpose, use has been made hitherto of a so-called “rainbow” test signal, which represents a colour profile with colours having identical saturation. Only the hue changes. In a vector representation with the axes CR/CB, such a test signal can be seen as a circle.

### SUMMARY OF THE INVENTION

The method according to the invention is characterized in that a test signal is generated in which the hue and the colour saturation are altered periodically. In this case, it is preferably provided that the colour saturation is altered more slowly than the hue, so that a colour circle with an increasing diameter is generated.

With the test signal used in the method according to the invention, which signal is represented on a monitor after passing through the device to be tested, or parts thereof, alterations in the colour space can be rapidly surveyed, so that the quality can be assessed in a simple manner. A spiral can be discerned in a CR/CB vector representation.

One development of the method according to the invention consists in the fact that colour value signals (R, G, B) are formed by sinusoidal oscillations which are phase-shifted by 120° with respect to one another, whose amplitudes rise and on which a DC component is superposed. In this case, it may additionally be provided that a luminance signal is furthermore formed by a sinusoidal oscillation whose amplitude rises and on which a DC component is superposed.

This development can be realized in a simple manner by calculating the individual points of the sinusoidal oscillations. In this case, it is preferably provided that the amplitudes rise linearly. Depending on the application, however, a non-linear rise may be advantageous—for example in order to test non-linear video signal channels.

Furthermore, it is preferably provided that the amplitude rise is repeated periodically at the line frequency. This produces vertical stripes in which, in each case over a picture line, each hue is represented a number of times with different saturation, the number of stripes being given by the ratio between the frequency of the sinusoidal oscillation and the line frequency.

The invention has the advantage that the quantities important for a signal processing in the colour space, such as saturation and hue, can be represented at a glance. One area of application for the invention is the assessment of colour corrections, in particular those which, besides the selection of a colour gamut to be altered, also permit selections with regard to the colour saturation of this colour gamut. The effect of such a colour correction and the quality of the processing of hue and colour saturation can be visualized well with the method according to the invention.

In an arrangement for generating a test signal for testing video-technological devices, it is provided, according to the invention, that colour value signals are stored in a memory, which signals are formed by sinusoidal oscillations which are phase-shifted by 120° with respect to one another, whose amplitudes rise and on which a DC component is superposed, and in that, for the read-out of the stored colour value signals a pixel counter is connected to address inputs of the memory.

One development of the arrangement according to the invention consists in the fact that a luminance signal is stored in a memory, which signal is formed by a sinusoidal oscillation whose amplitude rises and on which a DC component is superposed, and in that, for the read-out of the stored luminance signal, a pixel counter is connected to address inputs of the memory.

One advantageous refinement of the arrangement according to the invention provides for the amplitudes to rise linearly and/or for the amplitude rise to be repeated periodically at the line frequency.

### BRIEF DESCRIPTION OF THE DRAWING

An exemplary embodiment of the invention is illustrated in the drawing using a plurality of figures and is explained in more detail in the description below. In the figures:

FIG. 1 shows a representation of the test signals R, G, B,

FIG. 2 shows a representation of the test signal Y, and

FIG. 3 shows a block diagram of an arrangement according to the invention and its application in a film scanner.

### DESCRIPTION OF THE EXEMPLARY EMBODIMENT

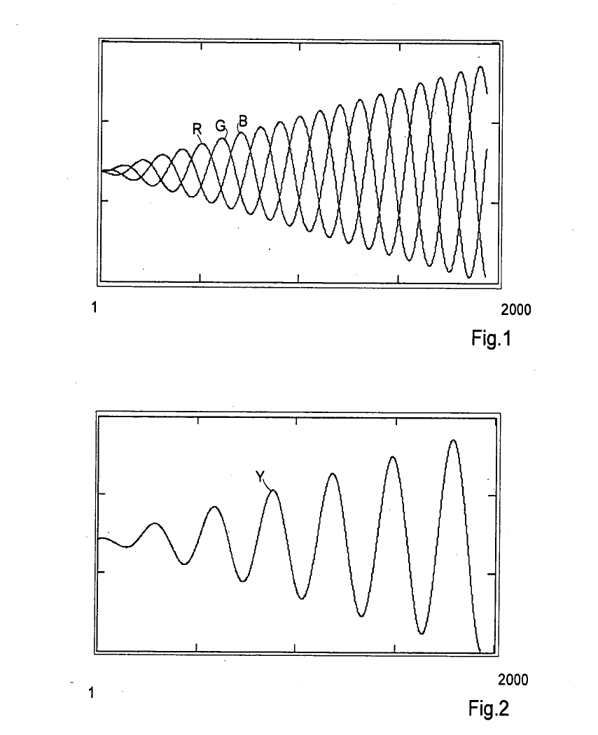

A line length of 1936 pixels is presupposed in the representations in accordance with FIG. 1 and FIG. 2. The test signals R, G, B and Y are calculated for each of these pixels. As can be seen from the figures, the test signals represent sinusoidal oscillations whose amplitudes—in the case of the example illustrated—rise linearly and have seven periods per line period. A DC component is superposed in each case in order to avoid negative values.

The test signals can be calculated by the following formulae in a computer and, for application, be written to a memory from which they are read out pixel by pixel.

The profile of the colour value signals is calculated as follows:

rᵢ=0.5-cos[2.π. (i−50)/300].0.5. [1−((1936−i)/1936)^{x}]

rᵢ=0.5-cos[2.π. (i−150)/300].0.5. [1−((1936−i)/1936)^{x}]

rᵢ=0.5-cos[2.π. (i−250)/300].0.5. [1−((1936−i)/1936)^{x}]

In this case, i is the number of the respective pixel within a line and 1936 is the total number of pixels in a line. The above formulae specify normalized colour values as fractions of 1 whose amplitude rises linearly if x=1. Other rise curves can also be chosen by means of a different exponent. In order to adapt the curves thus calculated to the quantization chosen in the respective video format, multiplication by a maximum value Max is provided, which is 13654 in the present example. The following then result for the colour value signals:

Ri=Max.rᵢ

Gi=Max.gᵢ

Bi=Max.bᵢ and for the luminance signal

Li=Max. (0.299rᵢ+0.587gᵢ+0.114bᵢ)

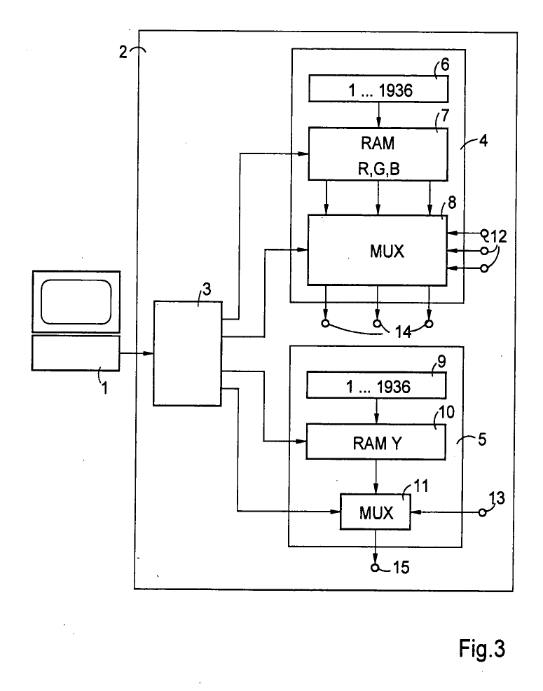

FIG. 3 shows an arrangement according to the invention using the example of a film scanner 2, merely illustrated diagrammatically. In a personal computer 1, as specified above, the test signals are calculated and written to random access memories 7 and 10 via a controller 3, which performs various control tasks in the film scanner 2. The random access memory 7 is part of a test signal generator 4 for colour value signals, while the random access memory 10 belongs to a test signal generator 5 for a luminance signal. The test signals generated are fed in instead of the video signals present during operation.

FIG. 3 illustrates the path of the video signals through inputs 12, 13 and outputs 14, 15, between which a multiplexer 8, 11 is located which, under the control of the controller 3, feeds either the video signals or the test signals to the outputs 14, 15. For the read-out of the test signals from the random access memories 7, 10, pixel counters 6, 9 are provided, which count from 1 to 1936, for example, in each line and forward the respective counter reading to address inputs of the random access memories 7, 10.

What is claimed is:

1. Method for testing video-technological devices, characterized by generating a test signal in which the hue and the colour saturation are periodically altered.

2. Method according to claim 1, characterized by altering the colour saturation more slowly than the hue, so that a colour circle with an increasing diameter is generated.

3. Method according to claim 1, characterized by forming colour value signals by sinusoidal oscillations which are phase-shifted by 120° with respect to one another, whose amplitudes rise and on which a DC component is superposed.

4. Method according to claim 1, characterized by a forming a luminance signal by a sinusoidal oscillation whose amplitude rises and on which a DC component is superposed.

5. Method according to claim 3, characterized by linearly rising the amplitudes.

6. Method according to claim 4, characterized by linearly rising the amplitudes.

7. Method according to claim 3, characterized by periodically repeating the amplitude rise at the line frequency.

8. Method according to claim 4, characterized by periodically repeating the amplitude rise at the line frequency.

9. Method according to claim 5, characterized by periodically repeating the amplitude rise at the line frequency.

10. Method according to claim 6, characterized by periodically repeating the amplitude rise at the line frequency.

11. Arrangement for generating a test signal for testing video-technological devices, characterized in that colour value signals are stored in a memory, which signals are formed by sinusoidal oscillations which are phase-shifted by 120° with respect to one another, whose amplitudes rise and on which a DC component is superposed, and in that, for the read-out of the stored colour value signals a pixel counter is connected to address inputs of the memory.

12. Arrangement according to claim 11, characterized in that a luminance signal is stored in a memory, which signal is formed by a sinusoidal oscillation whose amplitude rises and on which a DC component is superposed, and in that, for the read-out of the stored luminance signal, a pixel counter is connected to address inputs of the memory.

13. Arrangement according to claim 11, characterized in that the amplitudes rise linearly.

14. Arrangement according to claim 12, characterized in that the amplitudes rise linearly.

15. Arrangement according to claim 11, characterized in that the amplitude rise is repeated periodically at the line frequency.

16. Arrangement according to claim 12, characterized in that the amplitude rise is repeated periodically at the line frequency.

17. Arrangement according to claim 13, characterized in that the amplitude rise is repeated periodically at the line frequency.

18. Arrangement according to claims 14, characterized in that the amplitude rise is repeated periodically at the line frequency.
